(19) United States
(12) Patent Application Publication
(10) Pub. No.: US 2016/0057508 A1
(43) Pub. Date: Feb. 25, 2016

(54) INTERACTIVE OVERLAY FOR DIGITAL VIDEO

(71) Applicant: Video Grid Central LLC, Wilmington County of New Castle, DE (US)

(72) Inventor: Fred BORCHERDT, Newark, DE (US)

(21) Appl. No.: 14/837,979

(22) Filed: Aug. 27, 2015

Related U.S. Application Data
(63) Continuation-in-part of application No. 13/868,865, filed on Apr. 23, 2013, now abandoned.
(60) Provisional application No. 61/767,925, filed on Feb. 22, 2013.
(60) Provisional application No. 61/651,411, filed on May 24, 2012.

(51) Int. Cl. H04N 21/858; G06F 3/0482; H04N 21/235; G06F 3/0484

(52) U.S. Cl. CPC H04N 21/8583; G06F 3/0484; G06F 3/0482; H04N 21/2353

(57) ABSTRACT

Production and interaction with supplemented video is facilitated by overlaying a grid on a video frame. The grid comprises a plurality of grid regions each selectable to define a viewer selectable hotspot in the image of a video frame.

### CROSS-REFERENCE TO RELATED APPLICATIONS

This application is a continuation-in-part of U.S. patent application Ser. No. 13/868,865, filed Apr. 23, 2013, which claims the benefit of U.S. Provisional App. No. 61/651,411, filed May 24, 2012 and U.S. Provisional App. No. 61/767,925, filed Feb. 22, 2013.

### BACKGROUND OF THE INVENTION

The present invention relates to a method and system for producing supplemented digital videos.

Interactive video delivered to a television, computer or mobile device enables a viewer to obtain supplemental information about objects displayed in the video. The supplemental information may include, by way of examples only, a detailed description of an object displayed in the video, a means to purchase the object, or a link to a web site where additional information can be obtained and/or the object can be purchased.

U.S. Patent Publication No: US 2009/0276805 A1 discloses a method and system for generating interactive video. A video producer can define one or more a hotspots each corresponding to one or more objects displayed in a video sequence and a time when an image of the object(s) appears in the video. Typically, the hotspots are not visible to a viewer when the video is played back, but if the viewer moves a cursor or other position indicator to the hotspot in a displayed image, the hotspot is activated. A caption identifying the hotspot may be displayed and, if the viewer selects the hotspot, for example, by clicking a mouse button when the cursor is located on the hotspot, supplemental information stored in a separate computer accessible file and related to the object corresponding to the hotspot is shown in an area of the display. The supplemental information related to the hotspot can be, for examples, text, an image, an audio file, supplemental video, an interactive means of purchasing the object, or a link to a website enabling purchase or additional communication related to the object. Storing the supplemental information in a separate file facilitates updating of the information.

However, producing the supplemented video can be complicated and identifying and selecting the hotspots can be difficult and frustrating for a viewer. To create a hotspot associated with an object in a digital video sequence, the producer utilizes a drawing tool to define a hotspot area having shape at least roughly corresponding to the bitmapped image of the object with which the hotspot and the supplemental information will be associated. Since digital video comprises a sequence of images or frames and since the location, shape and size of the bitmapped image of an object frequently changes either as a result of the object's motion and/or the panning of the video capture device, it is frequently necessary for the producer to redefine the hotspot in a substantial number of the frames so that the hotspot will be active long enough for a viewer to locate and activate it. In addition, the size of an object's image and the relative locations of objects can change during a video sequence making it difficult for a viewer to track small objects and their corresponding hotspots and may cause hotspots to overlap, potentially confusing and frustrating a viewer.

What is desired, therefore, is a method and system for producing supplemented video that enables a producer of the video to easily define hotspots and facilitates a user's selection of hotspots in a supplemented video.

### BRIEF DESCRIPTION OF THE DRAWINGS

FIG. 1 is a block diagram of a computing environment useful for producing and viewing supplemented digital video.

FIG. 2 is a block diagram of a method of supplementing video.

FIG. 3 is an exemplary data set for supplemented video.

FIG. 4 is a view of an exemplary video frame with a superimposed grid.

FIG. 5 is a view of a second exemplary video frame with a superimposed grid.

FIG. 6 is a view of a third exemplary video frame with a superimposed second grid.

FIG. 7 is a view of a displayed exemplary video frame and related supplemental information.

FIG. 8 is an exemplary administrator interface.

FIG. 9 is an exemplary illustration of multiple computers in a networked environment.

FIG. 10 is an exemplary embodiment of a person with identifiable RFID tags.

FIG. 11 is an exemplary embodiment of a device with identifiable RFID tags.

FIG. 12 is an exemplary embodiment of associating RFID tags with locations over time.

FIG. 13 is an exemplary embodiment of RFID tags associated with multiple people.

FIG. 14 is an exemplary embodiment of a composite overlay system.

FIG. 15 is an exemplary embodiment of a graphical composite overlay.

### DETAILED DESCRIPTION OF PREFERRED EMBODIMENTS

Certain producers of digital video, for example, merchants, desire to supplement video with additional information related to objects appearing in a video sequence. This additional information may include, for example, a textual, visual and/or audio description of an object, an online means of purchasing the object or a link to a web site where the viewer can find additional information or purchase the object. Digital video can be supplemented by creating hotspots in the video that may be activated by a pointing device, such as a mouse controlled cursor, a light pointer, a touch screen, or otherwise. When a viewer of the video co-locates the cursor or other pointing device with the hotspot, the hotspot may be identified for the viewer and when the hotspot is activated, by, for example, clicking a mouse button, the supplemental information related to the hotspot displayed or otherwise provided to the viewer.

Digital video comprises a series images or frames displayed in rapid succession at a constant rate and a video producer can define a hotspot, corresponding to an object in the video, by specifying a time at which a frame including an image of the object will be displayed and a location of the image of the object in the frame. However, since the position, size and/or shape of the bitmapped image of an object is likely to be different in successive frames of video, it may be necessary for the producer redefine the hotspot in each of a large number of frames in which the hotspot is to be active. Viewers may also find that locating and activating a hotspot is difficult if the image of the object is small or if the object is close to a second object and its hotspot or if the image and hotspot are moving rapidly as the video progresses. The inventor considered the difficulties of defining hotspots associated with images in digital video and a viewer's difficulty in locating and selecting hotspots and concluded that production and viewing of supplemented digital video could be facilitated by associating hotspots with grid delimited regions of the portion of the display in which the video is being presented.

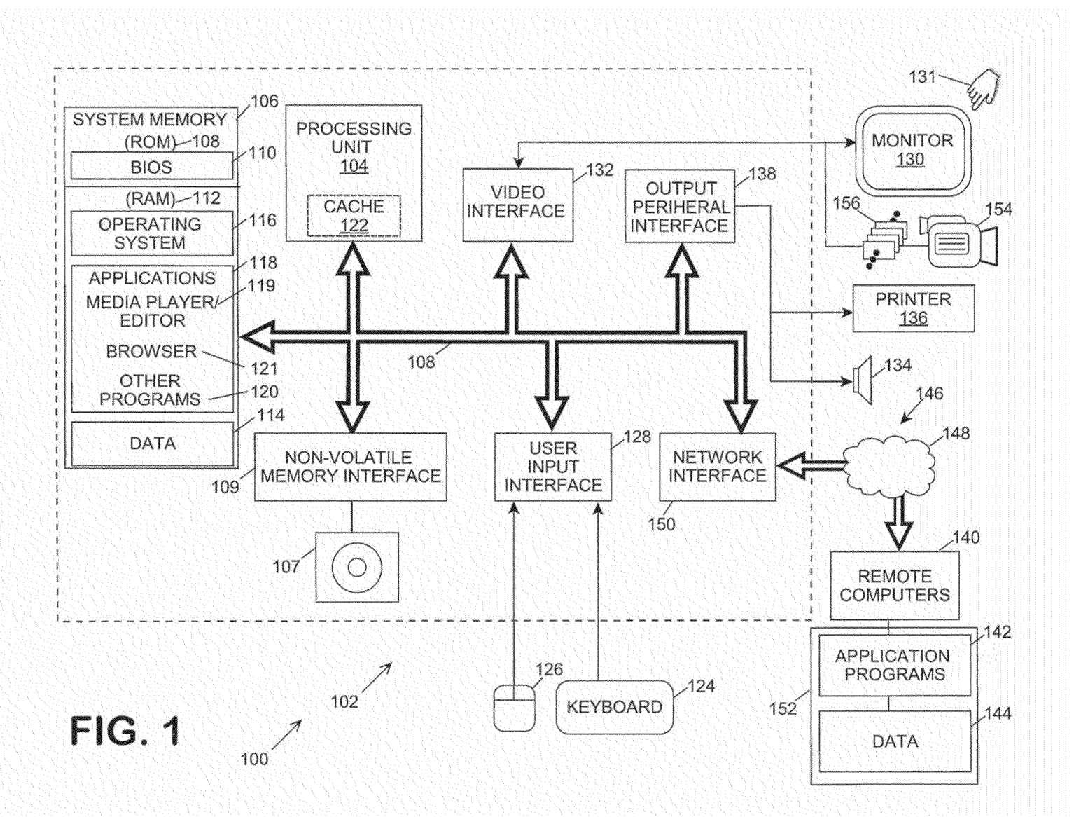

Referring in detail to the drawings where similar parts are identified by like reference numerals, and, more particularly to FIG. 1, the invention may be implemented in a suitable computing environment, such as the computing environment 100. The computing environment 100 is only one example of a suitable computing environment and is not intended to suggest any limitation as to the scope of use or functionality of the invention. The invention is operational with numerous general purpose or special purpose computing environments, systems or configurations. Examples of well known computing systems, environments, and/or configurations that may be suitable for use with the invention include, but are not limited to, personal computers, server computers, laptop, tablet, or hand-held devices including phones, multiprocessor systems, microprocessor-based systems, set top boxes, programmable consumer electronics, network PCs, minicomputers, mainframe computers, distributed computing environments that include any of the above systems or devices, and the like. The exemplary computing environment 100 should not be interpreted as having any dependency or requirement relating to or on any one or combination of components illustrated.

The invention may be described in the general context of computer-executable instructions, such as program modules, being executed by a computer. Generally, program modules include routines, programs, objects, components, data structures, and so forth that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An exemplary system for implementing the invention includes a general purpose computing device in the form of a computer 102. Components of the computer 102 may include, but are not limited to, a processing unit 104, a system memory 106, and a system bus 108 that couples various system components including the system memory to the processing unit. The system bus 108 may be any of several types of bus structures including, by way of examples, a memory bus or memory controller, a peripheral bus, and a local bus using any of a variety of bus architectures.

The memory of computer 102 also typically includes one or more computer-readable media. Computer-readable media can be any available media that can be accessed by the computer 102 and includes both volatile and nonvolatile media, and removable and non-removable media. By way of example, and not limitation, computer-readable media may comprise computer storage media including both volatile and nonvolatile, removable and non-removable media implemented in any method or technology for storage of information such as computer-readable instructions, data structures, program modules or other data and communication media typically embodying computer-readable instructions, data structures, program modules or other data in a modulated data signal such as a carrier wave or other transport mechanism and includes any information delivery media. Computer storage media 107 includes, but is not limited to, RAM, ROM, EEPROM, flash memory or other memory technology, CD-ROM, digital versatile disks (DVD) or other optical disk storage, magnetic cassettes, magnetic tape, magnetic disk storage or other storage devices, or any other medium which can be used to store the desired information and which can accessed by the computer 102 through a memory interface 109. Communication media, by way of example, and not limitation, includes wired media such as a wired network or direct-wired connection, and wireless media such as acoustic, RF, infrared and other wireless media. Combinations of the any of the above are also included within the scope of computer-readable media.

The system memory 106 includes computer storage media in the form of volatile and/or nonvolatile memory such as read only memory (ROM) 108 and random access memory (RAM) 112. A basic input/output system (BIOS) 110, containing the basic routines that help to transfer information between elements within computer 102, such as during start-up, is typically stored in ROM. RAM typically contains data 114 and/or program modules, including an operating system 116, application programs 118 including a web browser program 121 enabling access to content on the World Wide Web and a media player 119 which may include an editor, and other programs 120 that are immediately accessible to and/or presently being operated on by the processing unit 104 which may include, by way of example, and not limitation, an operating system, application programs, other program modules and program data. The processing unit 104 may also include or be connected to a cache 122 for storing more frequently used data.

A user may enter commands and information into the computer 102 through input devices such as a keyboard 124 and a pointing device 126, such as a mouse, trackball, touch pad, or touch screen monitor, including a capacitive touch screen monitor responsive to motion of a user's appendage, such as a hand 131. The user may also use a multi-touch enabled device to interact with the computer (or other computing device). Other input devices (not shown) may include a microphone, joystick, game pad, satellite dish, scanner, or the like. These and other input devices are often connected to the processing unit 104 through a user input interface 128 that is coupled to the system bus 108, but may be connected by other interface and bus structures, such as a parallel port, game port or a universal serial bus (USB). A monitor 130 or other type of display device is also connected to the system bus 108 via an interface, such as a video interface 132. Computer systems may also include other peripheral output devices such as speakers 134 and/or a printer 136, which may be connected to the system bus through an output peripheral interface 138.

The computer 102 commonly operates in a networked environment using logical connections to one or more remote computers, such as the remote computer 140. The remote computer 140 may be a personal computer, a server, a client, a router, a network PC, a peer device or other common network node, and typically includes many or all of the elements described above relative to the computer 102 including, but not limited too, application programs 142 and data 144 which is typically stored in a memory device 152. The logical connections 146 to the remote computers 140 may include a local area network (LAN) and a wide area network (WAN) and may also include other networks, such as intranets and the Internet 148. When used in a networking environment, the computer 102 is typically connected to the network through a network interface 150, such as network adapter, a modem, radio transceiver or other means for establishing communications over a network. In a networked environment, program modules and data, or portions thereof, used by the computer 102 may be stored in a remote storage device 152 connected to the remote computer 140. It will be appreciated that the network connections shown are exemplary and other means of establishing a communications link between computers may be used. In some cases, the annotation techniques described herein may be used in connection with services that identify objects, such as Google Goggles or an Augmented Reality application.

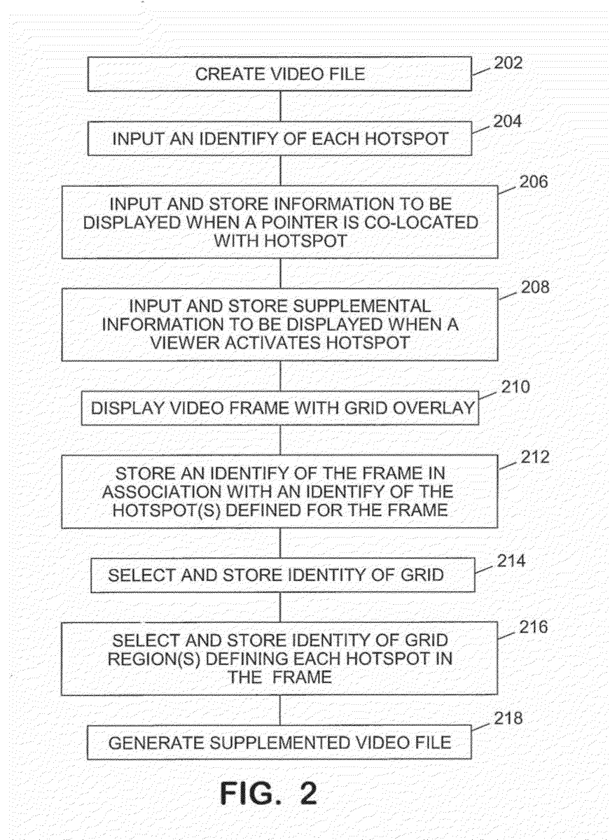

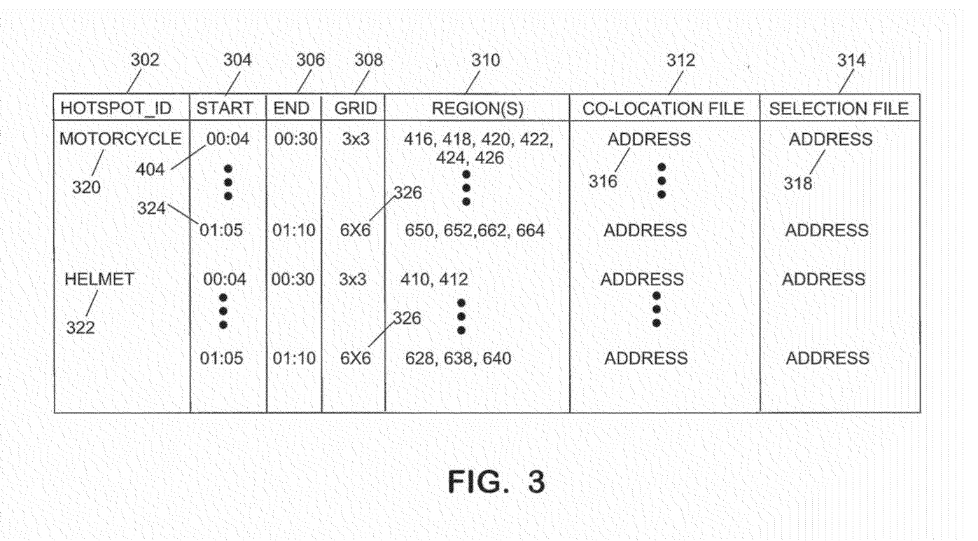

Digital video comprises a sequence of images or frames 156 captured by an image capture device 154 which is typically connected to a computing device such as the computer 102. Typically, video captures are encoded in a data stream which may be compressed for storage in a computer accessible memory and/or transmission. Referring FIG. 2, to produce the supplemented video, a video sequence is captured and stored and, if the stored video is compressed, it is decompressed to create a video file 202 enabling display and editing of individual frames by a media player and editor 119. Referring also to FIG. 3, a unique identification 302, by way of example only, a name of an object with which the hotspot will be associated, is input for each hotspot that will be created in the supplemented video sequence 204 and stored in the memory of the computing environment 100. If supplemental information, for examples, a label or an audio file, will be presented when the cursor or other pointing indicator is co-located with the hotspot (for example, upon “mouseover”), the “co-location” supplemental information 312 is produced and stored 206 in a file associated with the hotspot's identity 302. Supplemental information to be displayed or executed when the hotspot is activated 314, for example, by clicking a mouse button while the cursor is co-located with the hotspot or by touching a touch screen at the location of the hotspot in a displayed frame, is produced and stored 208 in a file associated with the hotspot identification 302 (or within the video file itself). The supplemental information may comprise, for examples only, text, audio or visual information, computer readable instructions initiating execution of an application program or a link to a web site and may be stored in a file separate from other hotspot data but linked to the respective hotspot data.

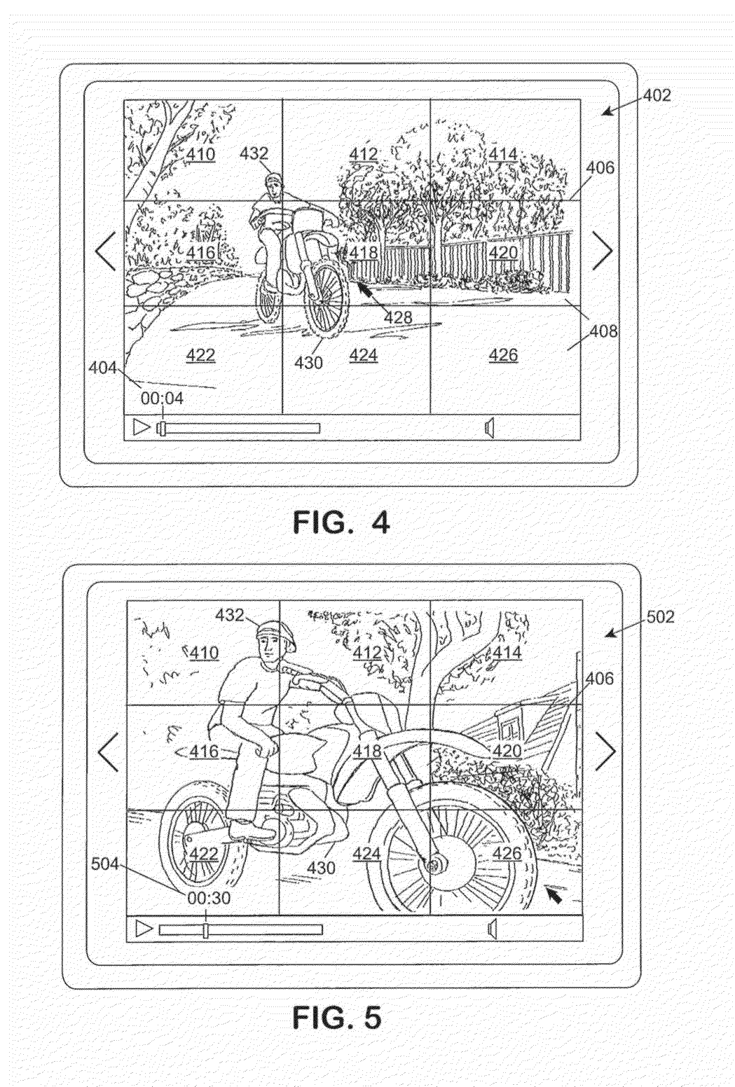

Referring to also FIG. 4, a frame 402 of the video is displayed 210 and an identification of the frame 304, such as the time 404 at which the frame is displayed in the video sequence, is stored 212 in association with the identification(s) 320, 322 of each of the hotspots to be created in the frame. A grid 406, selectable by the producer 214, is superimposed on the portion of the display in which the video is presented and its identity 308 stored in association with the identity of the frame. The grid 406 may be rendered using any suitable technique, such as for example flash and HTML5. The grid 406 divides the displayed frame into a plurality of regions 408, each selectable by the producer of the supplemented video. Preferably, the grid divides the displayed image into a small number of selectable regions and, more preferably, as illustrated in FIG. 4, the display area is divided into nine selectable regions 410, 412, 414, 416, 418, 420, 422, 424, 426 by a 3×3 grid. By co-locating a cursor or other position indicating mechanism 428 in one of the regions and operating a selection control, such as a mouse button or touch screen display, the producer can select the region 216 and store the identity of the region in a memory of the computing environment in association with the identity of the respective hotspot 310 to define the selected region as a portion of the hotspot in that frame. Additional regions can be selected and their identities stored in association with the hotspot identity increasing the size of the hotspot when the frame is displayed. For example, the producer might select some or all of regions 416, 418, 422, 424, 420, 426 as a hotspot 320 selectable by a viewer desiring to obtain supplemental information about the motorcycle 430. On the other hand, the user might select regions 410 and 412 to comprise a hotspot 322 selectable by a viewer desiring supplemental information about the rider's helmet 432. By subdividing the display area into a small number of selectable regions, large hotspots can be created which are easily locatable by a viewer even if the image of the object associated with hotspot is small. Alternatively, the user may define the hot spots using a multi-touch display to size the hot spots as appropriate.

Typically, the video camera is panned during video capture to keep the primary subject of the video in the approximate center of the displayed image. Since the size and shape of the hotspot is arbitrary and can occupy a substantial portion of the video display area, it may be unnecessary to redefine the hotspot for a substantial number of sequential frames. For example, referring to FIG. 5, the motorcycle's hotspot in frame 502 could be defined by the same regions 416, 418, 422, 424, 420, 426 that were selected for the hotspot in frame 402. The producer of the supplemented video does not need to redefine the hotspot in each frame but can store a range of frame identifications, a range of display times 304, 306, in association with a hotspot which is suitable for a plurality of sequential frames reducing the time to produce supplemented video.

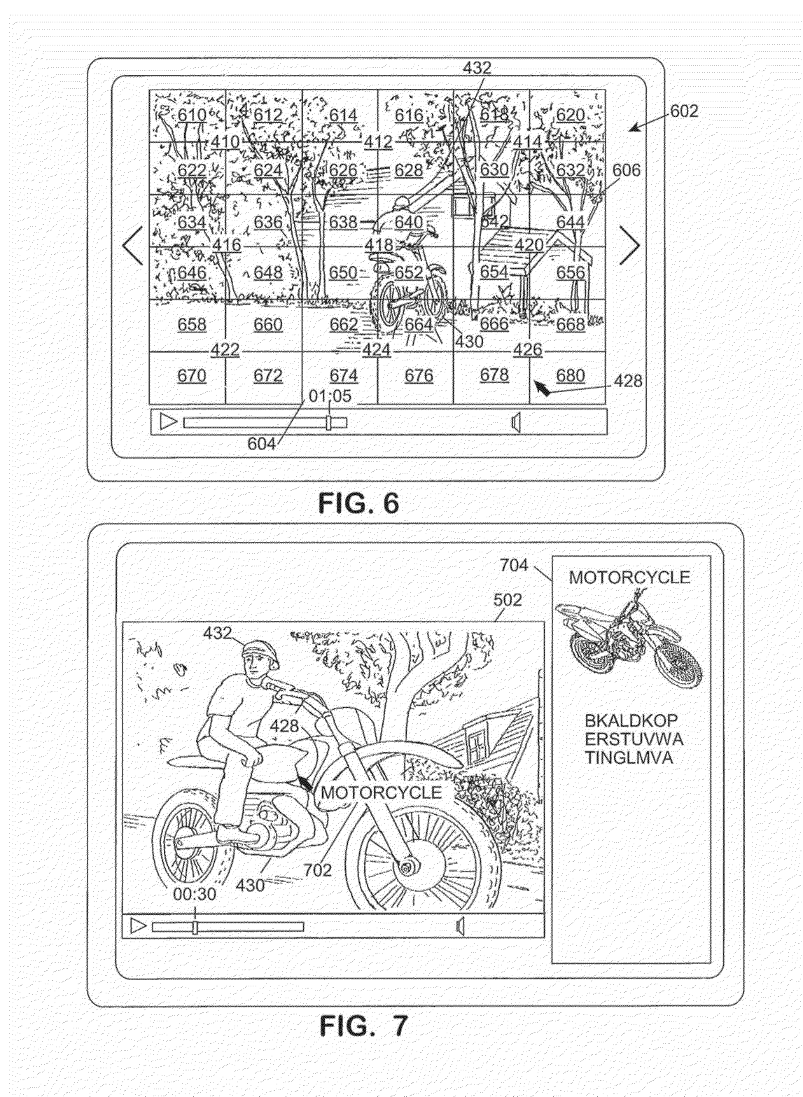

The producer of the supplemented video can redefine the grid and the hotspot when desired. The size of an object's image relative to the size of the frame commonly changes as the video captures motion of the included objects. Similarly, the relative positions of the images of moving objects commonly change during a video sequence as a result of relative displacement and the inventor realized that the images of two or more objects associated with respective hotspots may enter the same grid defined region as the video sequence advances. For example, referring to FIG. 6, as a result of motion away from the camera, the images of the motorcycle 430 and the helmet 432 are substantially smaller than the respective images in frame 502 as illustrated in FIG. 5. At the same time, the images of both the helmet 432 and a significant portion of the image of the motorcycle 430 are now located in what was the grid region 418 of the grid 406. To separate the hotspots for the motorcycle 430 and the helmet 432, the producer of the supplemented video can select a grid, for example, grid 602 comprising 36 regions 610-680, that sub-divides the grid regions of a coarser grid, such as grid 402. By sub-dividing the grid regions of the coarser grid, a hotspot can be defined for the helmet, for example, grid region 640, that is separate from a hotspot for the motorcycle, for example, grid regions 650, 652, 662, 664. While a hotspot can be limited to a single grid region, as with the coarser grid, a hotspot can be expanded to cover adjacent grid regions to make it easier for a viewer to locate the hotspot. For example, the hotspot associated with the helmet 432 could include grid regions 626, 628, 638 as well as region 640. Likewise the hotspot associated with the motorcycle 430 could be defined to include additional grid regions. By inputting a new display time or time range 324 in association with the hotspot, defining the grid selected by the producer 326 and defining the grid regions making up the hotspot, the producer can easily change the location and size of the hotspot as the video sequence proceeds. The supplemented video file containing data identifying the hotspots and computer readable paths to the supplemental information is generated and stored in a file in a computer accessible memory 218 or otherwise within the video file itself.

Referring to FIG. 7, the grid is preferably hidden, but could be displayed, when the supplemented video is played back by a web browser 121 or a media player 119 that accompanies the video or is stored as a standalone application. However, when a viewer moves a cursor or other position indicator 428 to co-locate the position indicator with the grid regions defining a hotspot, the co-location information for the hotspot, if any, is retrieved and presented to the user, for example as a label 702. If the user selects the hotspot by clicking a mouse button, tapping a touch screen or otherwise, the computing device locates 318 and presents the selection information 704 to the user.

Production and interaction with supplemented video is facilitated by superimposing a grid comprising a plurality of grid regions, each selectable to define a hotspot in the image or images of one or more video frames.

The grid may, if desired, take many forms. For example, the grid may be a set of circular patterns. For example, the grid may be a mathematically derived pattern. For example, the grip may be in the form of a cluster of honeycombs, overlapping splines, ellipses, and/or circles. Moreover, the grid may take the form of a three dimensional space. For example, having the grid in a three dimensional space is especially suitable for three dimensional games. The video may be a linear video, a non-linear video, video games, virtual worlds, etc. Further, the grid may only include part of the available video region, such that one or more portions of the video are not available for supplementation. This may be especially useful for video content that has advertisements in a particular region, or otherwise.

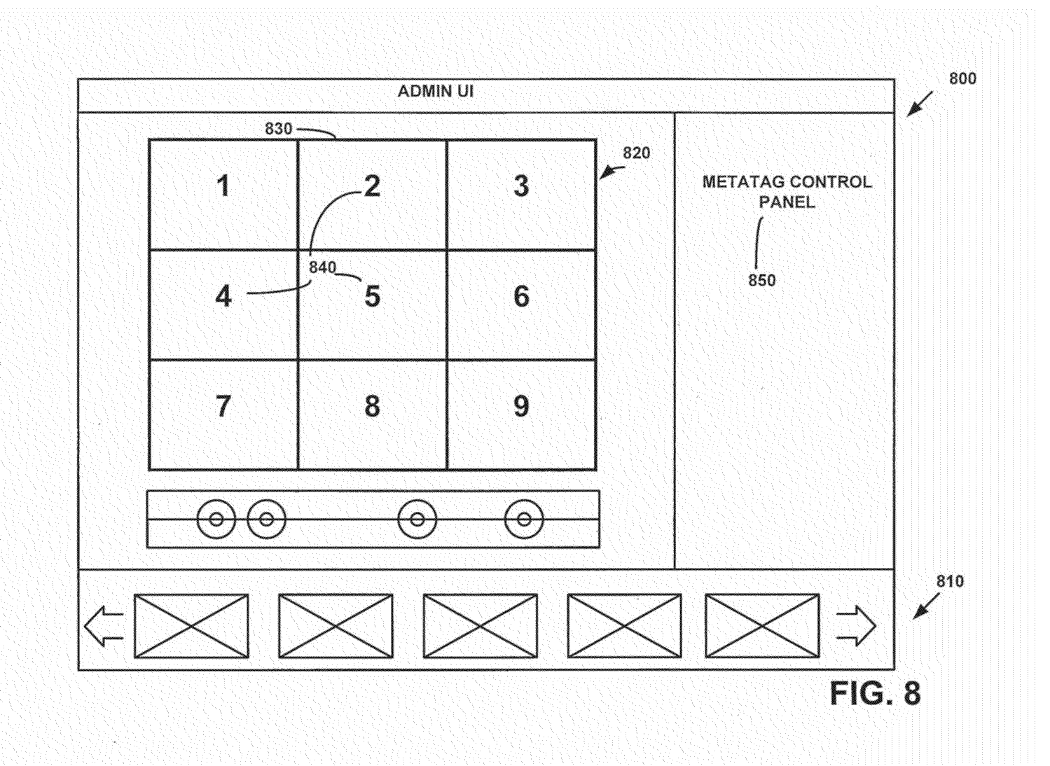

Referring to FIG. 8, to provide more flexibility for a producer to supplement the video content an administration interface 800 may be provided. The producer may launch the administrative interface for the supplementation of one or more different videos. The producer may select a location where one or more videos are available which may be presented in the form of a set of thumbnails 810 along the bottom of the administrative interface, where each thumbnail corresponds to a different video. The location of the set of thumbnails 810 may be modified by the producer. The available videos thumbnails 810 may be scrolled either to the right or to the left, by selecting the desired arrow or otherwise scrolling, so that the producer may select the desired video, When the desired video is selected by selecting its corresponding thumbnail, a video frame (such as the first frame of the video or otherwise the last frame shown if the video was previously viewed) is presented in the central region 820 of the administrative interface together with a default grid pattern overlay 830. The grid pattern overlay 830 may be modified by the producer, as desired. Also, the location of the grid pattern overlay 830 may be modified by the producer. The frame of the video being presented under the overlaid grid pattern may likewise be modified, as desired, to a different frame of the video.

By way of example, the producer may select one or more of the grids being presented. To assist the producer in the selection of the grids, each grid may be auto-populated with a grid number 840 in any suitable manner for ease of identification. The producer may select the grid identified by the number “5”, if desired. Each of the grid identifiers should be unique for the particular frame or group of frames, of the video. Upon the selection of a particular grid(s), the administrative interface may provide a metatag control panel or otherwise permit the population of data in the existing metatag control panel 850.

The metatag control panel 850 may include the characteristics of the particular grid pattern, the selectrid grid identifier(s), and other data. A descriptive name may be added to the grid(s) that is descriptive of the content included therein. Preferably, this descriptive data is not presented or otherwise available to a viewer of the video content.

The metatag control panel 850 may include a category drop down selector that is used to select from a list one or more categories that is descriptive of the content included in the selected grid(s). For example, the categories may include one or more of the following, appliances, antiques, barter, bikes, boats, books, business, computer, free, furniture, general, jewelry, materials, rvs, sporting, tickets, tools, wanted, arts, crafts, auto parts, baby, kids, beauty, health, cars, trucks, cds, dvds, vhs, cell phones, clothes, accessories, collectibles, electronics, farm, garden, garage sale, household, motorcycles, musical instruments, photo, video, toys, games, video gaming. Each of the selected categories may further include additional lists of sub-categories that may be selected.

The metatag control panel 850 may include a network location, such as a URL (universal resource located) that may likewise be included. This provides a link for the user to access exterior content to the video itself. Preferably, the link is provided in a shorthand manner, such as using a URL shortening service like Bit.ly.

The metatag control panel 850 may include auto generated twitter hashtags. In this manner, when a viewer views particular content a tweet may be automatically sent out. The monitoring of such tweets will provide information related to the number of times that one or more viewers viewed a particular selection of the video.

The metadata control panel 850 may include a description of the product or content. This description of the product is preferably provided to the viewer if the particular video content is selected. For example, in the case of a particular car the description may include specifications of that car together without useful information to the viewer of that particular car.

For the metadata control panel 850, a timecode may be included for identification purposes. The timecode is preferably in SMTP format, but may be in any other suitable format to identify a particular frame or series of frames of a video.

The metadata control panel 850 may include also store a “snapshop” of the region of the frame selected or otherwise the entire frame of video associated with a frame or set of frames. In this manner, a shapshot summary of the tagged metadata can be efficiently created from the metadata.

The metatadata control panel 850 may include a unique identification for the metadata associated with a particular frame or group of frames of the video. In this manner, the metadata may be uniquely associated with the video, and in particular a selected frame or group of frames of the video.

The manner in which the producer supplements the video may depend on the time available. Typically, the producer will review the video and include a limited number of tags, each of which with a limited amount of information, as a first hi level pass to identify the major components of the video. Then, the producer will make subsequent passes through the video content to provide further metadata to the initial tags that were not included in the first pass, plus additional tags, as desired. This permits the producer to more efficiently scrub the video content and provide a tag for all major items of interest in the video content. The resulting location of the tags within the video, together with the duration of those tags in the video, may be graphically displayed as a scrubber timeline 860. For example, the size and/or shape of the location icon on the scrubber timeline 860 may be modified based upon the number of frames for a particular tag.

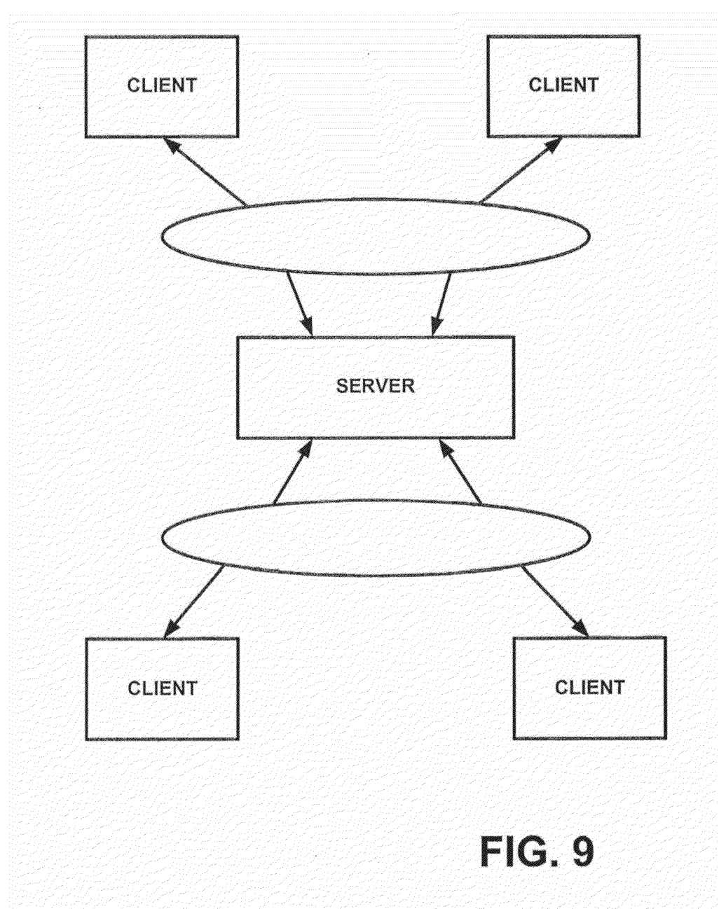

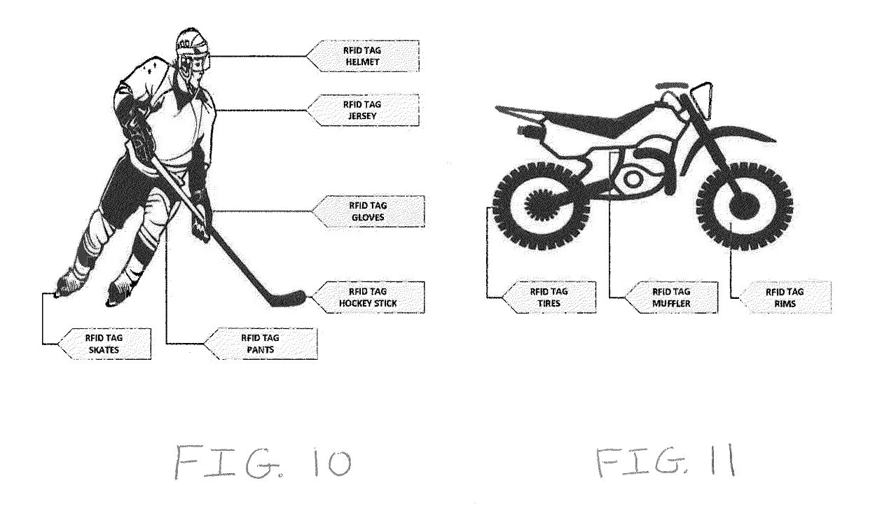

Referring to FIG. 9, another technique to supplement the video may include permitting each of a plurality of viewers to access a specialized interface which facilitates their supplementation of the video content with metadata content. In this manner, each of the viewers as they watch the video content or otherwise process the video content, may supplement the video content with metadata. The metadata provided by a particular viewer is available to that viewer when subsequently viewing the video, but is likewise provided to a centralized server. The centralized server receives metadata for one or more videos from a plurality of different viewers. For each of the videos, the server compiles the information from the different viewers and generates a comprehensive set of metadata. In some cases, the categories, descriptions, frames, series of frames, or otherwise may be modified to select those with the greatest likelihood based upon the general agreement among the viewers. For example, the selection of the frame(s) may be modified to select the frame(s) from a set of different frames that is representative of the viewers' selections. For example, the selected categories may be those categories that have the highest 5 selections representative of the viewer's selections.

The server may further include a database that records and otherwise tracks the viewer's interactions with the video content. When the viewer interacts with the video content, the video player associated with the viewer content may transmit data to the server to indicate what occurred. In this manner, the server may monitor the user interaction with the video, which is especially useful for determining what types of video content are of most interest to the viewer, and in particular what portions of the video content are of most interest to the viewer. The interaction with the video may be tracked anonymously or tracked through a login which identifies characteristics of the user, which facilitates the use of analytics to further characterize the suitability of the video content. The characteristics may include, for example, age, sex, location, weight, height, hobbies, interests, etc.

In some cases, it is desirable for the administrator to be he to select an object or location in the video content. The interface would then determine the size of the likely object indicated by the selection. The identified object may then be supplemented with metatag information.

In some cases, the system may attempt to identify the item selected to at least partially, or fully automatically, populate the metatag control panel. This permits more efficient supplementing of the video content.

While the manual input of the data for objects in the image, as defined by the grid system, it is a time consuming process and it not especially suitable for a real-time event such as a hockey game. While an automated image processing technique may be used to attempt to identify and automatically tag different aspects of the image, this tends to be computationally expensive, prone to errors, and may require specialized customization for the particular real-time event. Rather than using such an automated image processing technique, it is preferable to attach one or more radio frequency identification (“RFID”) tags to different objects of the scene being captured by an image capture device. RFID tags make use of electromagnetic fields to transfer data for the purpose of automatically identifying and tracking the RFID tags attached to objects. By way of example, some RFID tags are powered by electromagnetic induction from magnetic fields, other RFID tags collect energy from the interrogating radio waves and act as a passive transponder, other types of a local power source.

Referring to FIG. 10, a hockey player may include a plurality of separately identifiable RFID tags on their body or otherwise attached to their equipment. For example, a RFID tag may be attached to the player's helmet, the player's jersey, the player's glove, the player's hockey stick, the player's pants, and/or the player's skate(s). In this manner, several of the different portions of the player's body and equipment may be separately identifiable. Also, each of the RFID tags is associated with the respective portion of their body and/or equipment. For example, RFID tag 1 may be associated with the hockey stick while RFID tag 2 may be associated with the right hockey skate, etc.

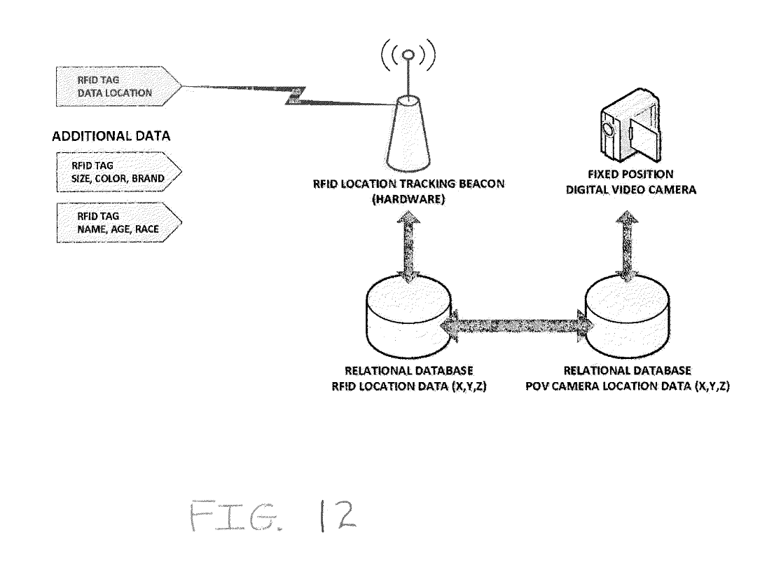

Referring to FIG. 11, a motorcycle used for motorcycle racing may include a plurality of separately identifiable RFID tags on the motorcycle. For example, a RFID tag may be attached to the motorcycle's tire(s), the motorcycle's muffler, and/or the motorcycle's rim(s). Also, each of the RFID tags is associated with the respective portion of the equipment. For example, RFID tag 1 may be associated with the back tire while RFID tag 2 may be associated with the muffler, etc.

Referring to FIG. 12, with one or more of the RFID tags being affixed to and associated with different objects a real-time tracking system may be used to track the location of each of the RFID tags over time in a real-time manner. One or more RFID location tracking beacons may be located in the vicinity of the RFID tags and sense data from each of the RFID tags. Based upon any suitable technique, such as a triangulation technique, the tracking beacons may determine a two dimensional and/or a three dimensional location of each of the RFID tags. The locations of each RFID tags over time may be determined as “absolute” spatial locations over time relative to the tracking beacon(s) (or other spatial location) and/or relative to other RFID tag(s) and/or any other data indicative of its location. In this manner, a relational database (or otherwise) may be used to store the RFID location data over time for each of the RFID tags.

One or more fixed position video capture devices may be used to capture the scene including the RFID tags which are moving over time. Preferably, the fixed position video capture devices capture a scene from known locations and/or positions. In this manner, the area captured by a particular image capture device may be known. The information from the database related to the RFID location data may be combined with the images captured from one or more of the image capture devices. In this manner, the system may automatically associate each of the RFID tags with an associated grid(s). In this manner, the system may automatically associate each of the RFID tags with the associated additional data corresponding to each of the RFID tags, and the corresponding associated grid(s).

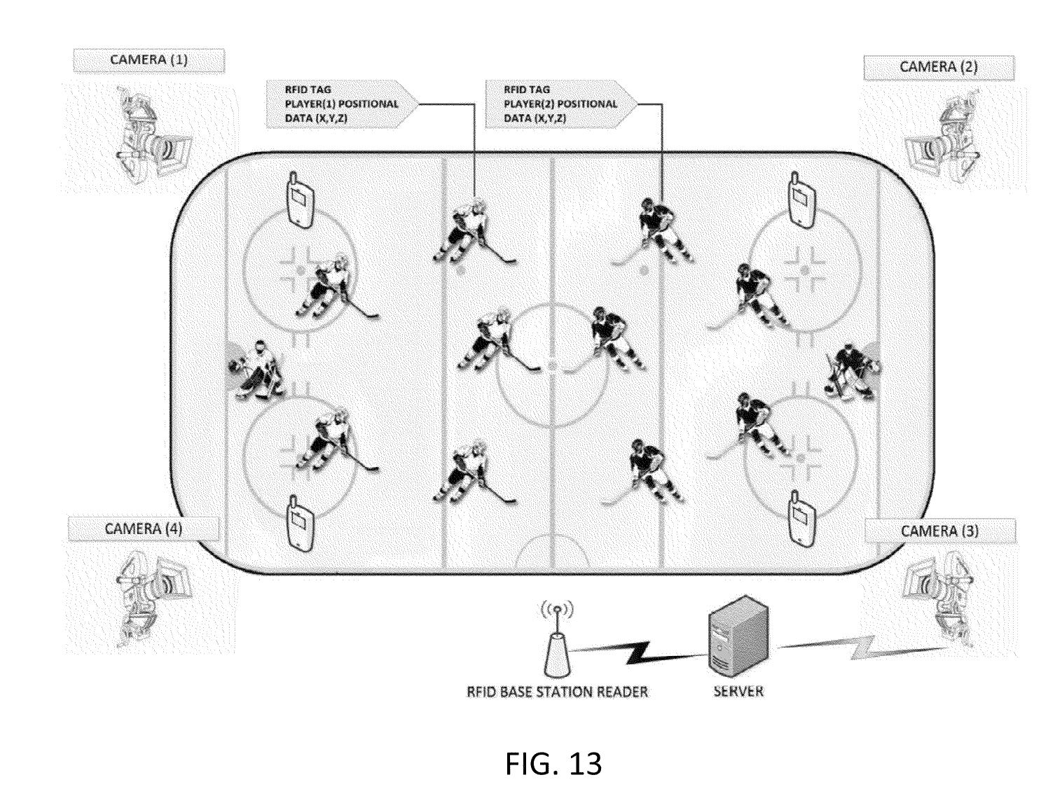

Referring to FIG. 13, an exemplary system is illustrated that includes a set of hockey players, each of which includes one or more RFID tags. One or more RFID base station readers (e.g., RFID location tracking beacons) may be used to capture and/or determine the location of each of the RFID tags. In addition, one or more image capture devices may be used to simultaneously capture the scene that includes one or more of the RFID tags. Using this system a real-time tracking system may be achieved for the video content. In addition, the system may be used to automatically create a non-real time RFID tracking system.

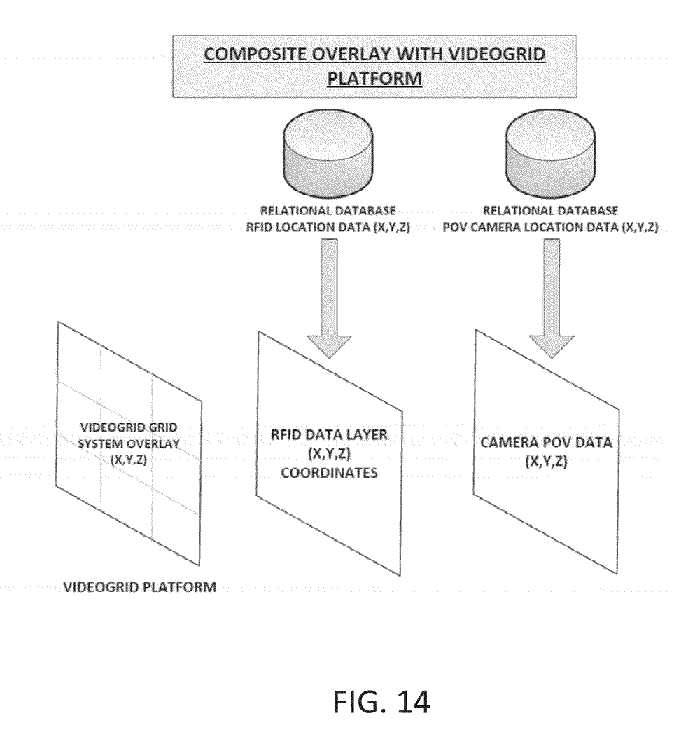

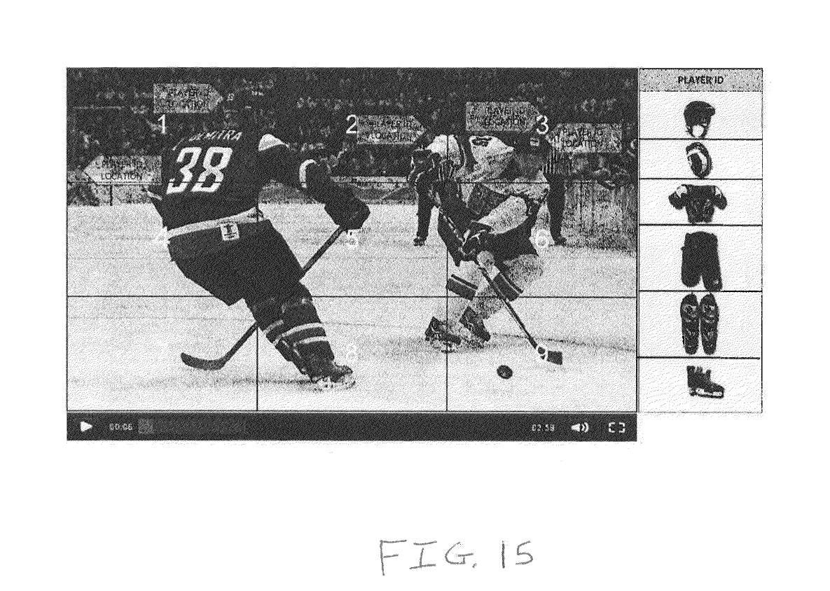

Referring to FIG. 14, a composite overlay may be achieved with the video grid system. The video content may include a video grid overlay, as previously described herein. The RFID coordinates may be a data layer with coordinates that are associated with the video grid overlay, such that each of the RFID tags may be associated with one or more grids of the video grid overlay for one or more temporal frames of the video. The camera video data from one or more points of view may likewise be associated with the video grid overlay.

Referring to FIG. 15, an exemplary composite overlay is shown. Each of the items identified by a corresponding RFID is illustrated as a graphical item on the right hand side of the display. Each of the RFID tags are likewise highlighted in some manner within the video. A video grid may likewise be illustrated on the display. The video grid may likewise be active in any of the techniques previously described.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A method of supplementing digital video with information to be displayed when elected by a viewer of said video, said method comprising the steps of:
(a) presenting a frame of said video on a portion of a display, said portion of said display divided into a plurality of selectable regions defined by a grid overlaying said portion;
(b) storing in a memory accessible to a computer an identification of a selected region in association with an identity of said frame and a datum to be displayed to a viewer when said viewer selects said selected region during display of said frame;
(c) where said datum to be said displayed is determined based upon a location of a RFID tag.

2. The method of supplementing digital video of claim 1 wherein selection of said region by said viewer comprises the steps of:
(a) co-locating a position indicator with said selected region; and
(b) activation of a selection control while said position indicator is co-located with said selected region.

3. The method of supplementing digital video of claim 1 further comprising the step of storing in said memory an additional datum to be presented to a viewer of said frame upon co-location of a position indicator with said selected region of said frame during display of said frame.

4. The method of supplementing digital video of claim 3 wherein selection of said region by said viewer comprises the steps of:
(a) co-locating said position indicator with said selected region; and
(b) activation of a selection control while said position indicator is co-located with said selected region.

5. The method of supplementing digital video of claim 1 wherein said identification of said frame comprises a display time for said frame.

6. The method of supplementing digital video of claim 1 wherein said identification of said frame comprises a range of display times during which a plurality of frames will be displayed and in which selection of said selected region by a viewer will cause display of said datum.

7. The method of supplementing digital video of claim 1 wherein said grid overlay defines a three by three array of regions.

8. The method of supplementing digital video of claim 1 further comprising the step of:
(a) enabling selection of one of a plurality of grid overlays, including at least one overlay comprising a region having bounding an area equivalent to of four regions of a second grid overlay; and
(b) storing in said memory in association with said identity of said frame an identification of said selected overlay.

9. A method of supplementing digital video, the method comprising the steps of:
(a) presenting a frame of said digital video on a portion of a display, said display portion divided into a plurality of regions defined by a grid overlaying said frame;
(b) storing in a memory of a computing device an identification of a hotspot to be defined in said frame;
(c) storing in said memory an identification of said frame in association with said identification of said hotspot;
(d) storing in said memory in association with said identification of said hotspot and said identification of said frame an identification of a selected region; and
(e) storing in said memory supplemental information in association with said identification of said hotspot, said supplemental information to be presented to a viewer of said frame upon activation of said hotspot;
(f) where said supplemental information to be said displayed is determined based upon a location of a RFID tag.

10. The method of supplementing digital video of claim 9 wherein activation of said hotspot by a viewer comprises the steps of:
(a) co-locating a position indicator with said selected region; and
(b) activation of a selection control while said position indicator is co-located with said selected region.

11. The method of supplementing digital video of claim 9 further comprising the step of storing in said memory additional supplemental information to be presented to a viewer of said frame upon co-location of a position indicator with said selected region.

12. The method of supplementing digital video of claim 11 wherein activation of said hotspot by a viewer comprises the steps of:
(a) co-locating said position indicator with said selected region; and
(b) activation of a selection control while said position indicator is co-located with said selected region.

13. The method of supplementing digital video of claim 9 wherein said identification of said frame comprises a display time for said frame.

14. The method of supplementing digital video of claim 9 wherein said identification of said frame comprises a range of display times in which said selected region will define said hotspot for a plurality of frames.

15. The method of supplementing digital video of claim 9 wherein said grid overlay defines a three by three array of regions.

16. The method of supplementing digital video of claim 9 wherein said grid overlay defines a six by six array of regions.

17. The method of supplementing digital video of claim 9 further comprising the steps of:
(a) storing in said memory an identification of a second frame in association with said identification of said hotspot; and
(b) storing in said memory in association with said identification of said hotspot and said identification of said second frame an identification of at least one selected region.

18. The method of supplementing digital video of claim 17 wherein said at least one selected region of said second frame is one of a plurality of sub-divisions of a region defined by said grid overlay of said frame.
